(19) United States
(12) Patent Application Publication
(10) Pub. No.: US 2014/0042787 A1
(43) Pub. Date: Feb. 13, 2014

(54) SEAT ADAPTER, MOTOR VEHICLE BENCH SEAT, SEAT ARRANGEMENT, MOTOR VEHICLE AND METHOD FOR THIS

(71) Applicant: GM GLOBAL TECHNOLOGY OPERATIONS LLC, Detroit, MI (US)

(72) Inventors: Michael HOEFGEN-ALLMANN, Riedstadt (DE); Eduard WOLF, Pfungstadt (DE)

(73) Assignee: GM GLOBAL TECHNOLOGY OPERATIONS LLC, Detroit, MI (US)

(21) Appl. No.: 13/959,793

(22) Filed: Aug. 6, 2013

(30) Foreign Application Priority Data
Aug. 8, 2012 (DE) 10 2012 015 596.4

(51) Int. Cl. B60N 2/06

(52) U.S. Cl. CPC B60N 2/06
USPC 297/232; 297/344.1; 29/428

(57) ABSTRACT

A motor vehicle is provided with a seat arrangement. The seat arrangement includes, but is not limited to a motor vehicle bench seat and a boundary of the interior. The motor vehicle bench seat is connected with the boundary of the interior via a seat adapter. In the seat adapter for fastening the motor vehicle seats to a motor vehicle floor, including, but not limited to a seat frame for fastening the motor vehicle seats to the motor vehicle floor, that includes, but is not limited to the seat frame has at least one track unit, facing the motor vehicle floor, with a track guide on the motor vehicle side and with a track slide on the frame side, cooperating therewith, which are pre-mounted on the seat frame, in order to move the seat frame with the motor vehicle seats along the motor vehicle floor.

### CROSS-REFERENCE TO RELATED APPLICATION

This application claims priority to German Patent Application No. 10 2012 015 596.4, filed Aug. 8, 2012, which is incorporated herein by reference in its entirety.

### TECHNICAL FIELD

The technical field relates to a seat adapter for motor vehicle seats, further relates to a motor vehicle bench seat for a motor vehicle, and further relates to a seat arrangement.

### BACKGROUND

Vehicle seats, in particular rear vehicle seats for rear bench seats are generally known. In a known solution, a seat structure is fastened directly to a motor vehicle floor. The floor is specially constructed or respectively shaped for this. Here, both the backrest and also the sitting surface and, if applicable, further linking arrangements such as a baby seat link, a belt link and suchlike are arranged on the floor.

From DE 10 2006 032 928 A1 a seat arrangement is known for a recreational vehicle with a bench seat and a seat underframe. The bench seat is connected with the seat underframe via a bearing, and is movable between a position of use and a position of non-use. In order to create a seat arrangement that enables as good a utilization of space as possible and is user-friendly, the bearing is constructed as a rotary sliding bearing.

In view of the foregoing, it is at least one object to provide an improved seat adapter, a motor vehicle bench seat, a seat arrangement, a motor vehicle and a method for this, which enable a simplified mounting and a more flexible use. In addition, other objects, desirable features and characteristics will become apparent from the subsequent summary and detailed description, and the appended claims, taken in conjunction with the accompanying drawings and this background.

### SUMMARY

A seat adapter is provided for motor vehicle seats, in particular in a seat adapter for a rear back bench seat of a motor vehicle, for fastening the motor vehicle seats to a motor vehicle floor, comprising a seat frame for fastening the motor vehicle seats to the motor vehicle floor, provision is made that the seat frame has at least one track unit facing the motor vehicle floor, with a track guide on the motor vehicle side and with a track slide cooperating therewith on the frame side, which are pre-mounted on the seat frame, in order to move the seat frame with the motor vehicle seats along the motor vehicle floor. In this way, the seat adapter can be mounted in a simple manner with the motor vehicle floor via the track units.

Preferably, the seat adapter has a suitable mount for at least one individual seat. Preferably, several mounts are provided for the collective fastening of several individual seats on the seat frame. For example, the motor vehicle seat can be arranged movably via the seat adapter, in particular displaceably longitudinally on the motor vehicle floor.

Here, the direction indication: “longitudinally” corresponds to a direction of travel of a vehicle. The corresponding track units are pre-mounted on the seat adapter. The track guide is preferably connected with the motor vehicle floor. The respective track slide is arranged movably in the corresponding track guide. Through the solution described above, several individual seats are mounted on a displaceable equipment carrier. The individual seats are, furthermore, foldable individually to a loading floor or respectively to a sitting part. The floor fastening takes place via the seat adapter, so that not every individual seat must be fastened to the motor vehicle floor. Hereby, a saving can be made with regard to connecting means such as screws. The individual seats are, in addition, longitudinally displaceable collectively, so that an additional storage space is able to be used underneath the individual seats, for example for a spare wheel. In addition, an assembly optimization is ensured. Through the pre-mounted seats on the equipment carrier, no individual seats have to be supplied on the line. The seat frame is fixedly connected with the track slide.

In an embodiment, the seat frame is constructed as a seat framework. The seat frame is preferably constructed as a framework construction or respectively as a seat framework, for example with several lattice-like beams. Preferably, the seat framework spans a plane on which a seat structure of a motor vehicle seat rests or several seat structures of several motor vehicle seats rest. The framework construction is particularly well suited for pre-stages of manufacture before the mounting with the motor vehicle floor. In particular, the framework is able to be handled easily, for example during the fastening of the individual seats on the framework or respectively on the framework construction.

Another embodiment includes that the seat framework has at least one longitudinal beam per track unit. Preferably, the seat framework has two parallel longitudinal beams spaced apart from one another. The longitudinal beams are constructed as a lateral boundary. The longitudinal beams extend here in the direction of travel of a motor vehicle. The longitudinal beams are preferably connected fixedly with the associated track slide.

Another further embodiment includes that the respective longitudinal beam is connected with the respective track slide. The track unit and the corresponding longitudinal beam are preferably aligned in the same direction, in particular in the direction of travel. The connection is preferably constructed in a stationary and/or rotatably fixed manner.

Accordingly, another embodiment includes the seat frame has two track units spaced apart from one another laterally. In an embodiment, the seat frame has at least one track unit. For example, the track unit is provided constructed centrally in the direction of travel. The track unit comprises the track guide and the track slide. The track slide moves guided along the track guide. The track guide is or becomes connected with the motor vehicle floor. The track slide is connected with corresponding parts of the seat frame, for example with the corresponding longitudinal beam.

A further embodiment includes the seat framework has several longitudinal beams that are connected with one another via at least one transverse beam. Preferably, the seat framework has two parallel longitudinal beams spaced apart from one another laterally. In another embodiment, further longitudinal beams are arranged between the longitudinal beams that function as a lateral boundary, for example to support the seat structure that is received on the seat framework. At least one transverse strut or respectively one transverse beam is provided for the construction of the framework.

Preferably, two transverse struts are provided, which connect the ends of the longitudinal beams with at least one other longitudinal beam, preferably its ends. In this way, a seat framework is created that spans a plane. The seat framework is preferably arranged directly onto the track slide.

Another further embodiment includes the seat frame has at least one reinforcing element for stabilizing the seat framework. In order to configure the seat framework in a more stable manner for the secure receiving of several motor vehicle seats, in an embodiment for example further transverse struts are provided as reinforcing elements. These are constructed for example obliquely to the longitudinal beams and/or to the transverse struts connecting the longitudinal beams. Preferably, the seat framework is constructed as a construction similar to a lattice.

The seat framework has a mount for the seat structure. The mount preferably has two support tubes running approximately parallel to one another in transverse direction, which span a surface for receiving a sitting part of a seat structure. Accordingly, the sitting part lies on this support structure. At a rear end, i.e., at a rear beam viewed in a longitudinal direction of the vehicle, a mount is arranged for a backrest structure of the seat structure. In order to compensate tolerances in manufacture after a joining together of the individual components of the support construction, or other tolerances, in an embodiment the seat frame has tolerance compensation device. These are present in addition to any connection and enable an adjusting of components in the range of up to a few millimeters or even a few centimeters. In an embodiment, the tolerance compensation takes place here in a transverse direction, i.e., along an extent direction of the two beams. In another embodiment, the tolerance compensation takes place in a longitudinal direction of the vehicle. The tolerance device is constructed for translatory and/or rotatory tolerance compensation. The tolerance adjustment takes place here reversibly and/or irreversibly. The tolerance compensating device can be arranged at any desired site of the seat frame.

An embodiment includes the compensation device on the motor vehicle seat side comprise at least one compensating hinge that is arranged on the seat frame. Preferably, the compensation device is constructed for the backrest structure. In order to construct a backrest so as to be foldable relative to a sitting part, the backrest structure is mounted foldably via a hinge or similar. The hinge is preferably arranged on the seat frame. In particular, the hinge is constructed as a compensating hinge, by which not only a pivotable or foldable mounting of the backrest structure is made possible, but by which in addition tolerances can be compensated. Therefore, the compensation device and the hinge or the hinges are constructed in an integrated manner.

In an embodiment, a hinge is constructed for a rotatory movement on a front beam or on a front transverse strut. A further embodiment provides a detent fitting and/or a folding mechanism for folding the backrest structure of the seat structure relative to the sitting part. The folding mechanism comprises a type of cam coupler mechanism, in particular at a rear section of the seat frame. In another embodiment, at a front section a hinge or several hinges are provided, which enable a rotary movement, in particular of the sitting part.

In an embodiment, the seat frame has a crash protection, by which the seat adapter is able to be secured on the motor vehicle side. In order to ensure a secure linking or connection of the seat adapter and/or of the seat frame with the motor vehicle structure, a corresponding crash protection is provided, which also holds the seat frame and/or the seat adapter securely in position in the case of an accident. The crash protection is constructed here for fastening on the motor vehicle structure, in particular on the motor vehicle floor. The crash protection is constructed for example as a sheet metal part which is arranged on a beam of the seat frame and can be connected detachably and/or non-detachably with the motor vehicle floor. Preferably, the crash protection is connected non-detachably with the motor vehicle floor, for example by riveting, gluing, welding and suchlike. In an embodiment, the crash protection is connected securely with the motor vehicle floor and attached to the seat frame. In another embodiment, the crash protection is connected securely with the seat frame and attached in a corresponding mount into the motor vehicle floor. In other embodiments, the crash protection is connected with other bearing structures of the motor vehicle.

Yet another embodiment includes at least one further linking element is arranged on the seat frame. In an embodiment, several linking elements are arranged on the seat frame. For example, linking elements are constructed as belts, belt buckles, baby seat belts, insertion possibilities for accessories and/or other adapters or connecting elements which increase comfort.

In addition, a motor vehicle bench seat is provided for a motor vehicle, in particular a rear back bench seat of a motor vehicle, comprising several seat structures and a fastening possibility for fastening the motor vehicle bench seat to a motor vehicle floor, provision is made that the fastening possibility is constructed as a previously described seat adapter. The motor vehicle bench seat is preferably constructed as a rear bench, in particular a rear bench with several individual seats. The rear bench comprises a seat structure on that an upholstery or suchlike is arranged. The seat structure comprises the backrest structure and the sitting part, which are preferably able to be folded with respect to one another. Preferably here the backrest structure is mounted so as to be foldable around the compensating hinge. In another embodiment, the backrest structure is able to be folded via the folding mechanism and/or via a detent fitting.

A seat arrangement is provided, in particular in a motor vehicle seat arrangement in an interior of a vehicle, comprising a boundary of the interior and a possibility for sitting that includes the possibility for sitting is constructed as a motor vehicle bench seat described above. The motor vehicle bench seat is arranged on the motor vehicle floor via the seat frame or respectively its track units. For this, connecting or linking sites are constructed accordingly on the motor vehicle floor, which are substantially identical or at least predominantly identical for several different seat adapters. The linking sites comprise, in particular openings, for example bores, threaded bores, and suchlike. In addition, in an embodiment, the linking sites have material reinforcements and/or reinforced materials. The seat frame is connected with the motor vehicle floor via these linking sites.

In an embodiment, the seat structure has a backrest structure that is arranged rotatably around the compensating hinge. In this way, the backrest structure is able to be folded relative to the sitting part. Tolerances, in particular manufacturing tolerances, can be compensated here in any desired directions via the possibility for compensation. The seat structure comprises the backrest structure and the sitting part.

A still further embodiment the boundary of the interior has at least one storage space arranged at least partially under the motor vehicle bench seat, which storage space is accessible or inaccessible by displacing the motor vehicle bench seat. In an embodiment, the boundary of the interior comprises at least a lower boundary, which comprises a storage space or several storage spaces, for example the motor vehicle floor. In addition to the motor vehicle floor, the boundary of the interior also comprises a lateral lining, lateral body sections, wheel arches and suchlike.

In addition, in an embodiment the boundary of the interior has a motor vehicle floor that has fastening regions for a fastening of various adapters. The motor vehicle floor is always constructed substantially identically for various motor vehicle seats. Different motor vehicle seats are able to be connected with the motor vehicle floor via different seat adapters. The motor vehicle floor preferably has fastening regions, connecting sites, linking sites, fastening sites and suchlike. These are constructed for example as through-openings, bores, blind holes, catch mechanisms, eyes, material reinforcements and suchlike. The linking sites are constructed substantially identically here for different seat configurations, so that always a standardized motor vehicle floor is provided for various solutions. In addition, the motor vehicle floor has corresponding storage compartments or respectively storage spaces. The storage spaces are constructed, for example, as a receptacle for spare wheels or for luggage. By a moving of the rear bench seat, these storage spaces are accessible or respectively inaccessible.

A motor vehicle is provided, in particular a passenger motor vehicle, comprising at least one seat arrangement, which includes the at least one seat arrangement is constructed as a seat arrangement described above. The vehicle is constructed, for example, as a limousine, station wagon, all-terrain vehicle, minibus, van, minivan, SUV or suchlike. The seat arrangement is preferably constructed as a rear seat arrangement.

In addition, a method is provided for mounting several motor vehicle seats in a motor vehicle, in particular of a rear motor vehicle bench seat comprising several motor vehicle seats in an interior of a motor vehicle, comprising the step of fastening the motor vehicle seats to a motor vehicle floor. The motor vehicle seats are pre-mounted on a collective seat adapter according to the above description and are fastened collectively to the motor vehicle floor via the fastening of the seat adapter. The seat frame is manufactured in a first step. The individual seats are mounted onto the seat frame. In addition, the track units are fitted on the seat frame. The rear bench seat therefore comprises the seats, the seat frame and the track units. The entire rear bench seat is fastened by fastening of the track units on the motor vehicle floor as a whole with the latter. In this way, the individual seats do not have to be fastened individually to the motor vehicle floor, but rather can be mounted collectively via a collective seat adapter with the motor vehicle floor.

### BRIEF DESCRIPTION OF THE DRAWINGS

The present invention will hereinafter be described in conjunction with the following drawing figures, wherein like numerals denote like elements, and:

FIG. 1 is diagrammatically in a perspective view a cutout of a motor vehicle with an embodiment of a seat arrangement in a first position with a stowed spare wheel;

FIG. 2 is diagrammatically in a perspective view the cutout according to FIG. 1 with the seat arrangement in a second position with a stowed spare wheel;

FIG. 3 is diagrammatically in a perspective view the cutout according to FIG. 1 and FIG. 2 with the seat arrangement in the second position and with a partially removed spare wheel;

FIG. 4 is diagrammatically in a perspective view a motor vehicle bench seat according to the example embodiment according to FIG. 1 to FIG. 3 with spare wheel in a position according to FIG. 1;

FIG. 5 is diagrammatically in a perspective view the motor vehicle bench seat according to the example embodiment according to FIG. 1 to FIG. 3 with spare wheel in a position according to FIG. 2;

FIG. 6 is diagrammatically in a perspective view the motor vehicle bench seat according to the example embodiment according to FIG. 1 to FIG. 3 with spare wheel in a position according to FIG. 3;

FIG. 7 is diagrammatically in another perspective view the motor vehicle bench seat with spare wheel according to FIG. 1 and FIG. 4 in an unfolded state;

FIG. 8 is diagrammatically in a perspective view the motor vehicle bench seat with spare wheel according to FIG. 1 and FIG. 4 in a completely folded state;

FIG. 9 is diagrammatically in a perspective view the motor vehicle bench seat with spare wheel according to FIG. 1 and FIG. 4 in a partially folded state;

FIG. 10 is diagrammatically in a further perspective view the seat arrangement; and

FIG. 11 is diagrammatically in yet another perspective view a cutout with an embodiment of the folding mechanism of the motor vehicle bench seat.

### DETAILED DESCRIPTION

The following detailed description is merely exemplary in nature and is not intended to limit application and uses. Furthermore, there is no intention to be bound by any theory presented in the preceding background or summary or the following detailed description.

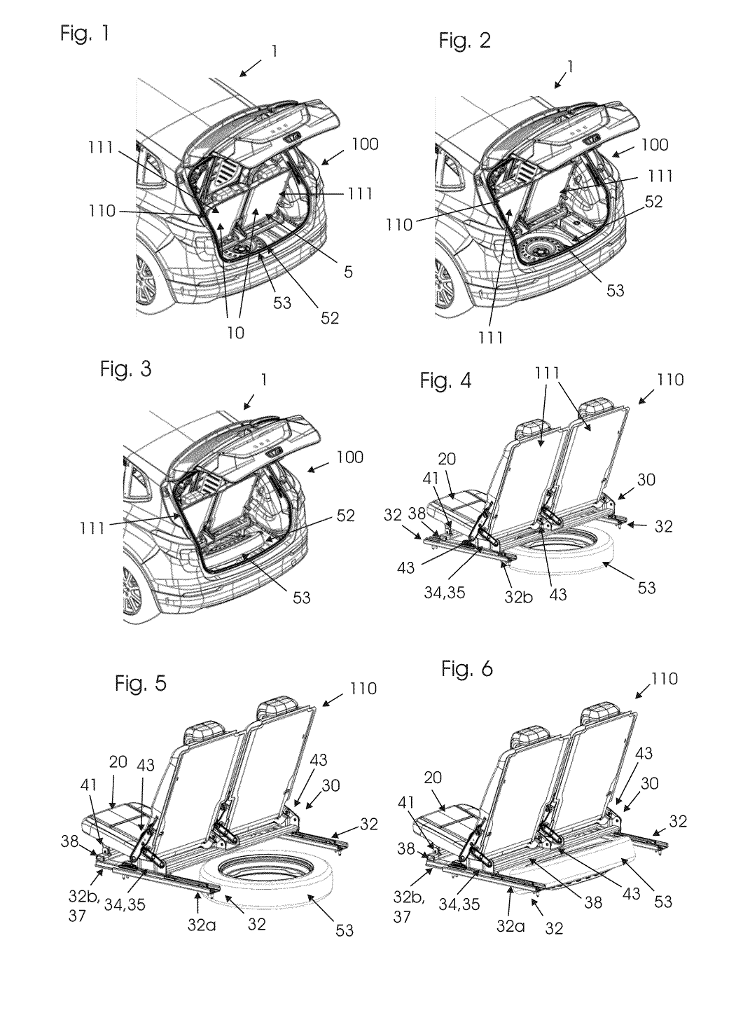

FIG. 1 to FIG. 11 show an example embodiment of a seat arrangement 100 of a motor vehicle 1 that is only illustrated partially here. The seat arrangement 100 comprises two seat structures 5 each with a backrest structure 10 and each with a sitting part 20. The seat structure 5 is connected with a motor vehicle floor 51 via a seat adapter 30, on which the seat structure 5 is arranged. The seat arrangement 100 further comprises a boundary 50 of the interior. The seat structures 5 together with the seat adapter 30 form a motor vehicle bench seat 110. The motor vehicle bench seat 110 is connected with the motor vehicle 1 via the boundary 50 of the interior. For this, the seat adapter 30 is connected with the motor vehicle floor 51 of the boundary 50 of the interior. The seat structure 5 is constructed as a foldable seat structure 5, in which the backrest structure 10 is arranged so as to be foldable relative to the seat part 20. A storage space 52, constructed in the motor vehicle floor 51, is situated under the motor vehicle bench seat 110.

The storage space 52 is accessible or respectively inaccessible by the movable motor vehicle bench seat 110, according to the position of the motor vehicle bench seat 110. In the illustrated example embodiment, the storage space 52 is constructed as a storage space for a spare wheel 53. The individual figures are described in more detail below. Identical reference numbers are used for identical components. Components which have already been described are not described in detail again, for reasons of better clarity.

FIG. 1 to FIG. 3 show different positions of the motor vehicle bench seat and of the spare wheel 53. FIG. 1 shows diagrammatically in a perspective view a cutout of the motor vehicle 1 with an embodiment of the seat arrangement 100 in a first position with a stowed spare wheel 53. FIG. 2 shows diagrammatically in a perspective view the cutout according to FIG. 1 with the seat arrangement 100 in a second position with a stowed spare wheel 53. FIG. 3 shows diagrammatically in a perspective view the cutout according to FIG. 1 and FIG. 2 with the seat arrangement in the second position and with a partially removed spare wheel 53.

In FIG. 1 the motor vehicle bench seat 110 is in a rear position or a position of use. The two motor vehicle seats, or abbreviated as individual seats 111, arranged on the collective seat adapter 30, are arranged adjacent to one another to form the motor vehicle bench seat 110. The backrest structure 5 of the two individual seats 111 is situated in an upright position. In FIG. 2, the two individual seats 111 are pushed forward collectively in the direction of travel via the collective seat adapter 30. In this way, the storage space 52 together with the spare wheel 53 arranged therein is exposed, so that it is able to be removed. A folding of the individual seats 111 is not necessary. In FIG. 3 the spare wheel 53 is illustrated in a partially removed position.

FIG. 4 to FIG. 6 show the positions of the motor vehicle bench seat 110 in isolation with the spare wheel 53. FIG. 4 shows diagrammatically in a perspective view the motor vehicle bench seat 111 according to the example embodiment according to FIG. 1 to FIG. 3 with spare wheel 53 in a position according to FIG. 1. FIG. 5 shows diagrammatically in a perspective view the motor vehicle bench seat 111 according to the example embodiment according to FIG. 1 to FIG. 3 with spare wheel 53 in a position according to FIG. 2. FIG. 6 shows diagrammatically in a perspective view the motor vehicle bench seat 111 according to the example embodiment according to FIG. 1 to FIG. 3 with spare wheel 53 in a position according to FIG. 3.

According to FIG. 4 the motor vehicle bench seat 111 is in a rear position or respectively in a position of use. The spare wheel 53 is arranged in the rear position inaccessibly beneath the motor vehicle bench seat 111. The seat adapter 30 has laterally in each case a track unit 32. The seat adapter 30 has in addition a seat frame 34 which is constructed here as seat frame 35. The individual seats 111 are arranged on the collective seat frame 34. The seat frame 34 is connected movably with the motor vehicle floor 51 via the track unit 32. For the movable linking, the track unit 32 comprises in each case a track guide 32a and a track slide 32b. The track guide 32a is securely connected with the motor vehicle floor 51. The track slide 32b is arranged movably in the track guide 32a. The seat frame 35 is connected with the track slide 32b. On moving the seat frame 35 along the track guide 32a, the track slide 32b or respectively the part of the seat frame 35 arranged thereon in a front position of the motor vehicle bench seat 110 projects partially out over the track guide 32a, as can be readily seen in FIG. 5 and FIG. 6.

In this front position, the spare wheel 53 is exposed and, as illustrated in FIG. 6, can be easily removed. In the example embodiment which is shown, the seat frame 35 comprises laterally in each case a longitudinal beam 37. The two longitudinal beams 37 are connected with one another at their ends via corresponding transverse beams or respectively transverse struts 38. Corresponding mounts are arranged on the beams for the seat structure 5 or respectively for the backrest structure 10 and/or the sitting part 20. On the front transverse beam 38 a hinge 41 or another pivot bearing is arranged, via which the sitting part 20 is pivotable in the direction of travel. A folding mechanism 43 for a folding of the backrest structure 10 relative to the seat structure 5 is arranged on the longitudinal beams.

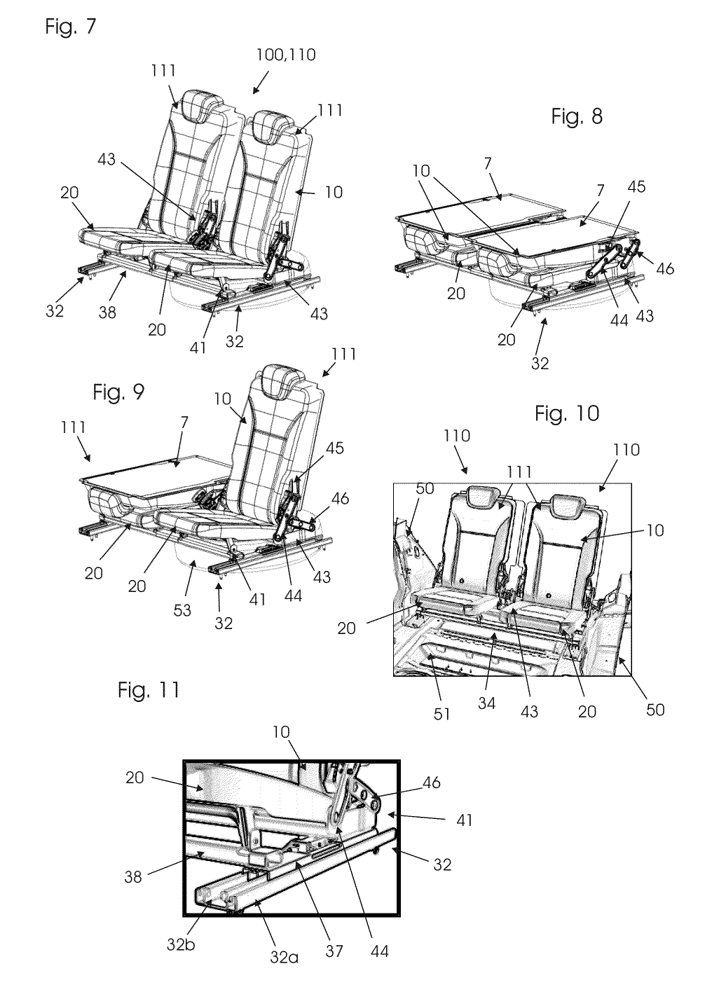

The folding mechanism 43 is constructed in the manner of a cam coupler mechanism. A lever of the folding mechanism 43 is connected by one end rotatably with the longitudinal beam 37. A further lever, which is in operative connection with the first lever, is rotatably arranged in the region of the rear transverse beam 38. The folding mechanism 43 which is thus formed is associated respectively laterally with an individual seat 111. The folding of the backrest structure 10 is illustrated more clearly in FIG. 7 to FIG. 9.

FIG. 7 to FIG. 9 show the motor vehicle bench seat 111 in various states. FIG. 7 shows diagrammatically in another perspective view the motor vehicle bench seat 111 with spare wheel 53 according to FIG. 1 and FIG. 4 in a not folded or non-folded state. FIG. 8 shows diagrammatically in a perspective view the motor vehicle bench seat 111 with spare wheel 53 according to FIG. 1 and FIG. 4 in a completely folded state. FIG. 9 shows diagrammatically in a perspective view the motor vehicle bench seat 111 with spare wheel 53 according to FIG. 1 and FIG. 4 in a partially folded state.

In FIG. 7 the two backrest structures 10 of the two individual seats 111 are in an upright or ready-to-use position. In order to bring the motor vehicle bench seat 110 into a storage position according to FIG. 8, the first lever 44 moves along a guide 45 along the backrest structure 10 up to the stop position which is shown. The second lever 46 rotates about the linking site on the seat frame 35 and likewise moves into the illustrated stop position. In so doing, the backrest structures 10 are folded forwards onto the sitting parts 20. A rear side of the backrest structures has a storage surface 7, so that objects can be placed thereon. Each individual seat 111 is mounted here so as to be foldable individually, as can be readily seen in FIG. 9. In FIG. 9 the right-hand seat in the figure is in an upright position. The left-hand seat is completely folded.

FIG. 10 shows diagrammatically the seat arrangement 100 in a further perspective view. The backrest structures 10 are all situated in an upright position. The motor vehicle bench seat 110 is constructed as a rear bench seat and is incorporated between the boundary 50 of the interior. The two individual seats 111 are movably connected with the motor vehicle floor 51 via the collective seat frame 34.

FIG. 11 shows diagrammatically in yet another perspective view a cutout with an embodiment of the folding mechanism 43 of the motor vehicle bench seat 110. The track unit 32 comprises the track guide 32a and the track slide 32b. The track guide 32a is constructed approximately U-shaped or C-shaped and is securely connected with the motor vehicle floor 51. The track slide 32b, likewise constructed approximately U-shaped or C-shaped, is arranged in the track guide 32a.

The longitudinal beam 37 is fastened on this track slide 32b, so that said longitudinal beam is movable with the track slide 32b along the track guide 32a. The two longitudinal beams 37 are connected with one another via the transverse beam 38, so that they take part in a movement in synchronism. The folding mechanism 43 is arranged on the longitudinal beam 37. The first lever 44 is rotatably mounted here. The second lever 46 is likewise arranged so as to be rotatably mounted and cooperates with the first lever 44. In this way, the backrest structure 10 is able to be folded onto the sitting part 20.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A seat adapter for motor vehicle seats for fastening the a motor vehicle seats on a motor vehicle floor, comprising:
a seat frame that is configured to fasten the motor vehicle seats to the motor vehicle floor,
the seat frame comprising:
a track unit, that faces the motor vehicle floor;
a track guide on a motor vehicle side; and
a track slide on a frame side cooperating therewith that are pre-mounted on the seat frame in order to move the seat frame with the motor vehicle seats along the motor vehicle floor.

2. The seat adapter according to claim 2, wherein the seat frame is constructed as a seat framework.

3. The seat adapter according to claim 2, wherein the seat framework comprises a longitudinal beam for the track unit.

4. The seat adapter according to claim 3, wherein the longitudinal beam is connected with the track slide.

5. The seat adapter according to claim 1, wherein the seat frame comprises a second track units spaced apart from the track unit.

6. The seat adapter according to claim 3, wherein the seat framework comprises a second longitudinal beam connected to the longitudinal beam via transverse beam.

7. The seat adapter according to claim 1, wherein the seat frame comprises a reinforcing element that is configured to stabilize the seat framework.

8. A motor vehicle bench seat for a motor vehicle, comprising:
a plurality of seat structures and a seat adapter that is configured to fasten the motor vehicle bench seat to a motor vehicle floor, the seat adapter comprises:
a seat frame that is configured to fasten the motor vehicle bench seat to the motor vehicle floor,
the seat frame comprising:
a track unit that faces the motor vehicle floor;
a track guide on a motor vehicle side; and
a track slide on a frame side cooperating therewith that are pre-mounted on the seat frame in order to move the seat frame with the motor vehicle bench seat along the motor vehicle floor.

9. (canceled)

10. (canceled)

11. (canceled)

12. A method for mounting motor vehicle seats in a motor vehicle, comprising several motor vehicle seats in a motor vehicle interior, comprising:
fastening the motor vehicle seats to a motor vehicle floor, wherein
pre-mounting the motor vehicle seats on a collective seat adapter, the collective seat adapter comprising:
a seat frame that is configured to fasten the motor vehicle seats to the motor vehicle floor
the seat frame comprising:
a track unit that faces the motor vehicle floor;
a track guide on a motor vehicle side; and
a track slide on a frame side cooperating therewith that are pre-mounted on the seat frame in order to move the seat frame with the motor vehicle seats along the motor vehicle floor,
and, wherein the fastening the motor vehicle seats comprises collectively fastening the collective seat adapter to the motor vehicle floor.

13. The motor vehicle bench seat according to claim 8, wherein the seat frame is constructed as a seat framework.

14. The motor vehicle bench seat according to claim 13, wherein the seat framework comprises a longitudinal beam for the track unit.

15. The motor vehicle bench seat according to claim 14, wherein the longitudinal beam is connected with the track slide.

16. The motor vehicle bench seat according to claim 8, wherein the seat frame comprises a second track unit spaced apart from the track unit.

17. The motor vehicle bench seat according to claim 14, wherein the seat framework comprises a second longitudinal beam connected to the longitudinal beam via a transverse beam.

18. The motor vehicle bench seat according to claim 13, wherein the seat frame comprises a reinforcing element that is configured to stabilize the seat framework.
